(19) United States
(12) Patent Application Publication
(10) Pub. No.: US 2024/0019120 A1
(43) Pub. Date: Jan. 18, 2024

(54) WASTE ORGANIC SOLIDS BURNER INTEGRATED INTO EXISTING ETHANOL PLANT

(71) Applicant: LE3 Technology LLC, De Soto, KS (US)

(72) Inventor: Scott A. Lucas, De Soto, KS (US)

(21) Appl. No.: 18/223,362

(22) Filed: Jul. 18, 2023

Related U.S. Application Data
(60) Provisional application No. 63/390,176, filed on Jul. 18, 2022.

(51) Int. Cl. F23G 7/04; B01J 19/00; F23G 7/06

(52) U.S. Cl. CPC F23G 7/04; B01J 19/0013; F23G 7/06; B01J 2219/00157; B01J 2219/00128; F23J 15/025

(57) ABSTRACT

A waste organic solids burner integrated with an ethanol plant includes a burner receiving waste organic syrup, combustion air dryer exhaust and natural gas from the ethanol plant. A baghouse receives burner exhaust and extracts particulate matter and hot gas, which is sent to a waste boiler. Cool gas from the waste boiler is sent to a heat recovery scrubber, from which hot water is sent to the ethanol plant as an energy source.

### CROSS-REFERENCE TO RELATED APPLICATION

This application claims priority in U.S. Provisional Patent Application No. 63/390,176, filed Jul. 18, 2023, which is incorporated herein by reference.

### BACKGROUND OF THE INVENTION

Waste organic streams are produced at the ethanol plant that have little market value. These waste organic streams are residual materials after higher value components, such as ethanol and high protein animal feed, have been separated and recovered.

These waste organic streams can be condensed at the ethanol plant to produce a high solids syrup product that can be fed to a burner system where the energy contained in the organic compounds can be converted to heat energy and this heat energy will be used to replace natural gas at the ethanol plant.

The burner system will be integrated with the plant product dryers and will be used to permanently modify how the ethanol plant operates these dryers.

### BRIEF DESCRIPTION OF THE DRAWINGS

The drawings constitute a part of this specification and include exemplary embodiments of the present invention and illustrate various objects and features thereof.

FIG. 1 is a schematic diagram of a waste organic solid burner system embodying an aspect of the present invention.

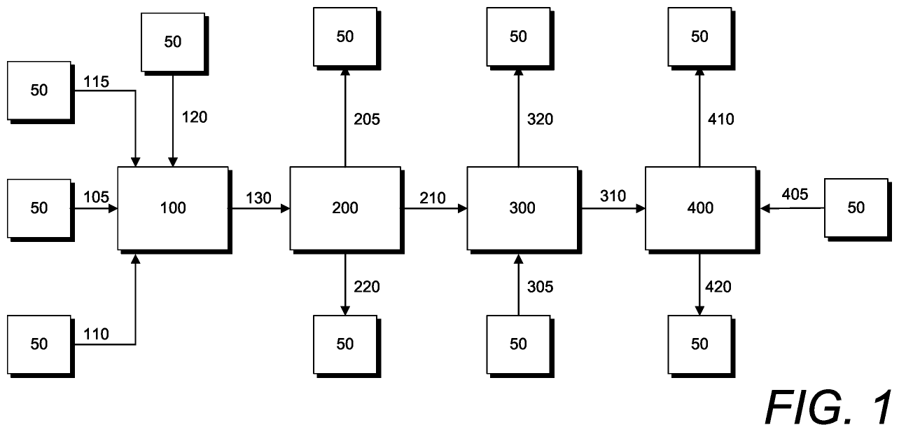

### DETAILED DESCRIPTION OF THE PREFERRED EMBODIMENT

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

### II. Preferred Embodiment Waste Organic Solids Burner Integrated into Existing Ethanol Plant

Waste organic syrup, 120, from the ethanol plant at approximately 65% wt to 85% wt solids will be fed to the syrup burner, 100. Dryer exhaust, 105, from the ethanol plant, 50, will be fed to the syrup burner 100 along with natural gas, 110.

Combustion air, 115, will be fed to the burner 100. This stream will contain a portion of ground agricultural residue such as corn stover to increase the amount of heat energy produced at the burner. The amount of ground agricultural material will be adjusted as needed to increase the energy production to match the plant needs.

These combined streams will sustain a sufficient flame in the syrup burner, 100, to allow for near complete combustion of the waste organic syrup, 120, and the agricultural residue contained in the combustion air.

The burner exhaust, 130, at approximately 1000 F from the syrup burner will be fed to a high temperature baghouse, 200, where ash and other particulate matter are removed from the hot exhaust stream. The ash, 220, from the baghouse will be collected and marketed as an organic fertilizer. Clean hot gas streams, 205 and 210, will exit the baghouse for further use.

A portion of the clean hot gas, 205, from the baghouse will be sent to the ethanol plant to be used at the existing product dryers to replace natural gas usage.

The remaining hot gas, 210, will be fed to a waste heat boiler, 300, where the hot gas is used to provide heat to the boiler which will produce steam, 320, at a pressure in the range of approximately 125 to 450 pounds per square inch gage that will be used at the ethanol plant. Boiler feedwater, 305, will be fed to the boiler from the plant.

The hot gas, 210, will be cooled at the waste heat boiler exiting the boiler system producing a cool gas stream, 310, at approximately 250 F.

This cool gas stream will be fed to the heat recovery scrubber, 400, where the gas stream is contacted with a warm water feed, 405, at approximately 160 F. The gas stream will be cooled to approximately 170 F producing the treated gas exhaust, 410, that will be vented to the atmosphere. Hot water, 420, will exit the bottom of the heat recovery scrubber, 400, and will be utilized at the existing ethanol plant as an energy source.

### III. Conclusion

It is to be understood that the invention can be embodied in various forms and is not to be limited to the examples specifically discussed above. The range of components and configurations which can be utilized in the practice of the present invention is virtually unlimited.

Having thus described the invention, what is claimed as new and desired to be secured by Letters Patent is:

1. A waste organic solids burner integrated into an existing ethanol plant, which comprises:
a burner configured for receiving dryer exhaust, combustion air waste organic syrup and natural gas from an existing ethanol plant;
a high temperature baghouse configured for receiving burner exhaust from the syrup burner;
said baghouse configured for ash and other particulate material from the exhaust stream;
said baghouse configured for exhausting clean on gas streams;
one of said clean gas streams exhausted by said baghouse being sent to the ethanol plant for use by product dryers therein, in place of natural gas;
another said clean gas streams exhausted by said baghouse being fed to a waste boiler for producing steam for use in the ethanol plant;
boiler feed water being fed from the boiler to the ethanol plant;
hot gas from the baghouse being cooled the waste heat boiler to produce a cool gas stream;
said gas stream being fed to a heat recovery scrubber for contact with warm water feed;
said gas stream being cooled to produce treated gas exhaust for venting to the atmosphere; and
hot water exiting the bottom of the heat recovery scrubber for utilization by the ethanol plant as an energy source.
